(19) United States
(12) Patent Application Publication
(10) Pub. No.: US 2014/0076629 A1
(43) Pub. Date: Mar. 20, 2014

(54) SPLICE FOR A MINERAL INSULATED CABLE

(71) Applicant: Petrospec Engineering Ltd., Edmonton (CA)

(72) Inventor: William Diesel, Sherwood Park (CA)

(73) Assignee: Petrospec Engineering Ltd., Edmonton (CA)

(21) Appl. No.: 14/022,910

(22) Filed: Sep. 10, 2013

(30) Foreign Application Priority Data
Sep. 19, 2012 (CA) 2789975

(51) Int. Cl. H01R 4/70; H01R 43/20

(52) U.S. Cl. CPC H01R 4/70; H01R 43/20
USPC 174/84 R; 29/825; 29/869

(57) ABSTRACT

A splice for splicing opposed ends of mineral insulated cable, where each mineral insulated cable has a jacket surrounding a conductor, and mineral insulation insulating the conductor from the jacket, where the mineral insulation is recessed from the end of each mineral insulated cable, such that a length of conductor is exposed. The splice has an insulating sleeve disposed over a portion of the exposed length of each conductor, the insulating sleeve being positioned immediately adjacent to the mineral insulation. A sealant seals the insulating sleeve to the mineral insulation. A connector electrically connects the conductors at a point between the respective insulating sleeves. A cover covers the ends of the mineral insulated cables.

### FIELD

This relates to a splice and a method of splicing a mineral insulated cable.

### BACKGROUND

Mineral insulated cables are metal jacketed cables with one or more conductors surrounded by a mineral powder that electrically isolates the conductor from the metal jacket. In the oil and gas industry, mineral insulated cables are often used in high temperature or otherwise hostile wellbores in instrumentation strings, as heater cables, and for other purposes. Mineral insulated cables are also used in other industries, such as in nuclear plants. It is often necessary to splice together mineral insulated cables, such as to increase the length of the cable, or to attach a separate section, such as a heater or instrumentation section, to the cable. An example of a method of splicing mineral insulated cables can be found in United States Patent Publication No. 2012/0090174 (Harmason et al.) entitled “Mechanical Compaction of Insulator for Insulated Conductor Splices.”

### SUMMARY

There is provided a splice for splicing opposed ends of mineral insulated cable, each mineral insulated cable comprising a jacket surrounding a conductor, and mineral insulation insulating the conductor from the jacket, the mineral insulation being recessed from the end of each mineral insulated cable, such that a length of conductor is exposed. The splice comprise an insulating sleeve disposed over a portion of the exposed length of each conductor, the insulating sleeve being positioned immediately adjacent to the mineral insulation. A sealant seals the insulating sleeve to the mineral insulation. A connector electrically connects the conductors at a point between the respective insulating sleeves. A cover covers the ends of the mineral insulated cables.

According to another aspect, the sealant may comprise a potting compound, which may be aqueous or non-aqueous. The sealant may comprise one or more layers. The sealant may be injected between the electrically insulating sleeve and the conductor. The sealant may fill the recess at the end of each mineral insulated cable.

According to another aspect, the connector may comprise a sleeve of electrically conductive material, or a weld, or both.

According to another aspect, the cover may be filled with mineral insulation. The cover may further comprises a sliding sleeve positioned between the cover and one of the mineral insulated cable, the sliding sleeve being withdrawn to form an opening through which mineral insulation is inserted.

According to an aspect, there is provided a method of preparing a mineral insulated cable for splicing, the mineral insulated cable comprising a jacket, a conductor positioned within the jacket and mineral insulation separating the conductor from the jacket, the method comprising the steps of forming a cavity at an end of the mineral insulated cable within the jacket by removing a portion of the mineral insulation immediately adjacent to the conductor; placing a dielectric sleeve over the conductor such that a first end of the sleeve is adjacent to the extends into the cavity; and sealing the dielectric sleeve in the cavity.

According to another aspect, the method may further comprise the steps of electrically connecting the conductors of each mineral insulated cable to each other; placing a cover that extends between the jackets of each mineral insulated cable and covers the connection of the conductors; and filling the cover with mineral insulation.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of a mineral insulated cable with a cavity.

FIG. 2 is a side elevation view in section of a mineral insulated cable prepared for splicing.

FIG. 3 is a side elevation view in section of a mineral insulated cable prepared for splicing in an alternative manner.

FIG. 4 is a side elevation view in section of a mineral insulated cable prepared for splicing in an alternative manner.

FIG. 5 is a side elevation view in section of a mineral insulated cable connected to a second mineral insulated cable.

FIG. 6 is a side elevation view in section of a mineral insulated cable splice being filled with mineral insulation

FIG. 7 is a side elevation view in section of a completed mineral insulated cable splice.

### DETAILED DESCRIPTION

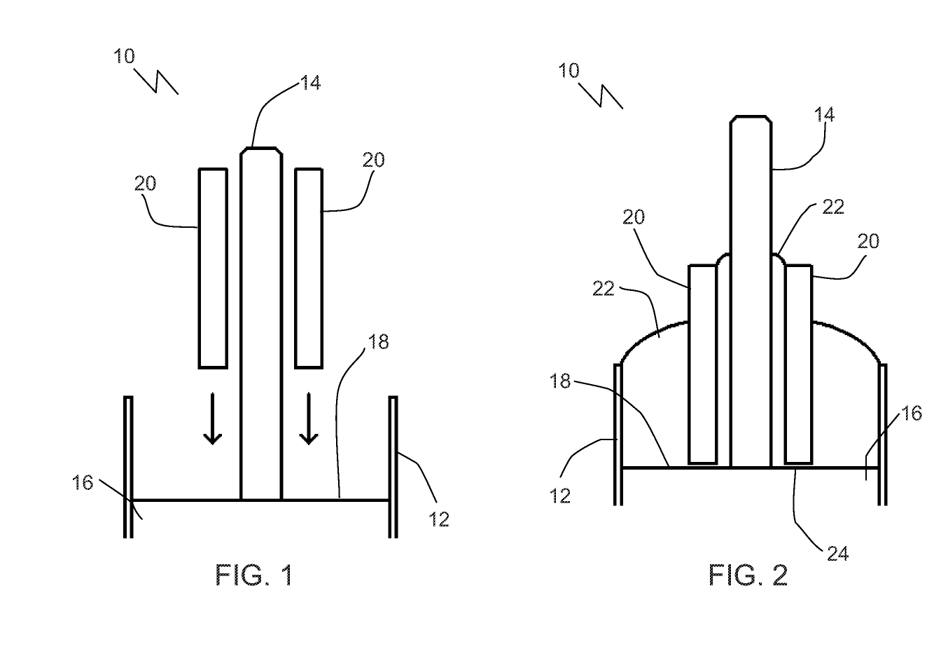

Referring to FIG. 1, a mineral insulated cable 10 has a jacket 12, a conductor 14 that is positioned within jacket 12, and mineral insulation 16 that separates conductor 14 from jacket 12. If there is a single conductor 14, it may be coaxially positioned within jacket 12. It will be understood that, while the discussion below is given in terms of a single conductor 14, there may be more than one conductor. Similar principles may be applied to splice cables having a plurality of conductors with minor variations as will be understood by a person of ordinary skill. Jacket 12 is used to protect mineral insulated cable 10, and may be made from various materials. Generally speaking, jacket 12 will be a metal that is able to withstand high temperature and potentially corrosive environments. The actual cladding material for jacket 12 will depend on the intended use and the conditions that are to be encountered. In some circumstances, stainless steel may be used, while in others metal alloys may be used. These alloys will be selected based on the environments they are designed to withstand, such as high temperature, corrosive environments, etc. Conductor 14 may be a low resistance conductor or a high resistance conductor if it is to be used as a heating element. Mineral insulation 16 preferably has a high dielectric strength, or high electrical resistance, to prevent arcing between conductor 14 and jacket 12. Commonly used insulation materials include inorganic powders, such as magnesium oxide or other similar materials. The actual composition of mineral insulated cables are well known and may be designed to suit the intended use of the cable. Accordingly, it will be understood that the discussion above is only a general discussion, and variations according to design and materials will be apparent to those skilled in the art.

The first step is to remove a portion of mineral insulation 16 within jacket 12 to form a cavity 18 around conductor 14. Cavity 18 may be formed by digging out mineral insulation, or by other known means. While mineral insulation is packed in tightly during manufacturing, it is a powder, which allows it to be carved out or otherwise removed. Cavity 18 is sufficiently deep to allow the necessary components to be installed to create a proper splice, but not too deep that it becomes unnecessarily difficult to form, to risk damaging jacket 12, or to make the splice unnecessarily long. Cavity 18 may extend radially out to jacket 12, although this is not necessary. A layer of mineral insulation 16 may remain on the inner surface of jacket 12, however this may affect the adhesion of the bonding material described below. Jacket 12 is preferably trimmed back as well to expose a certain length of conductor 14 to allow for a proper splice to be made.

Once cavity 18 has been formed, a dielectric sleeve 20 is threaded over conductor 14, with one end that extends into cavity 18. It is possible that dielectric sleeve 20 is only positioned within cavity 18, however, referring to FIG. 2, it preferably extends out from cavity 18 for reasons that will be described below. As shown, dielectric sleeve 20 preferably leaves a certain length of conductor exposed to allow a proper connection with the other conductor it is to be connected with. Sleeve 20 may be made from a ceramic material, or other material that is both dielectric and able to withstand high temperatures. Preferably, sleeve 20 is sufficiently dielectric that it would be able to prevent arcing between conductor 14 and jacket 12 even without insulation 16. Other materials and designs may be selected based on the intended use and available materials.

Referring to FIG. 2, sleeve 20 is sealed within cavity 18 using a bonding material 22. Preferably, bonding material 22 is potting material that is commonly used in electrical applications. Bonding material 22 should be selected to withstand the conditions that will be encountered by cable 10, such as the high temperature and physical manipulation that is applied to cable 10 during use. Preferably, bonding material 22 has a high dielectric value and is a sealant. In one embodiment, a potting material with properties similar to a cement may be used. Two common types of cement-like potting material include aqueous and non-aqueous. If an aqueous potting material is used, there is a risk of introducing moisture into the mineral insulation adjacent to the splice, which can cause problems. This may be remedied by drilling a hole in jacket 12 adjacent to splice and applying heat to cause any moisture to evaporate through the hole, and then welding the hole shut to create a hermetic seal. This may also be prevented by providing multiple layers of sealant, as shown in FIG. 4, where a first layer 22a separates a second layer 22b. For example, first layer 22a may be a small layer of non-aqueous potting material, while second layer 22b is aqueous potting material, such that the non-aqueous potting material prevents undesirable material such as moisture from migrating into mineral insulation 16. Other design approaches may also be used. However, these issues may be avoided by using a non-aqueous potting material or other bonding material.

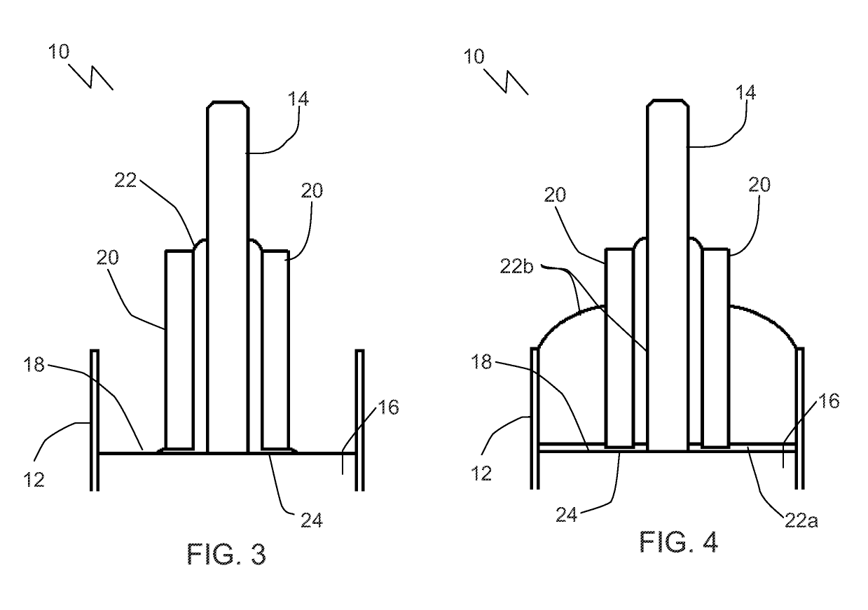

It has been found that one of the most common points for arcing to occur is at the back of cavity 18, i.e., where dielectric sleeve 20 contacts mineral insulation 16 as shown in FIG. 2, identified by reference numeral 24. This is at least partially due to the fact that it is the most difficult location to re-insulate after conductors 14 have been connected, and the mineral insulation at this point is often the loosest after splicing. Accordingly, when sleeve 20 is sealed within cavity 18, it is important to ensure that sleeve 20 is sealed to the back to prevent any arcing from occurring between jacket 12 and conductor 14. In one embodiment, referring to FIG. 2, bonding material 22 fills cavity 18 and the space between sleeve 20 and conductor 14. Bonding material 22 may extend part way up sleeve 20 as shown, or sleeve 20 may be embedded within sleeve 20. In another embodiment, referring to FIG. 3, bonding material 22 may be limited to sealing between dielectric sleeve 20 and the back 24 of cavity 18. In this example, the remaining cavity would likely be filled with mineral insulation, or another compound, at a later stage. In another embodiment, referring to FIG. 4, more than one layer 22a and 22b of sealant may be used, as described previously. It will be understood that other designs or combinations of design elements described above that seal sleeve 20 within cavity 18 may also be used.

Another location that has a high risk of arcing is at the very end of jacket 12, due to the Corona effect at an edge. However, sleeve 20 preferably extends past the end of jacket 12 in both directions as depicted, and has a high dielectric value to reduce this risk.

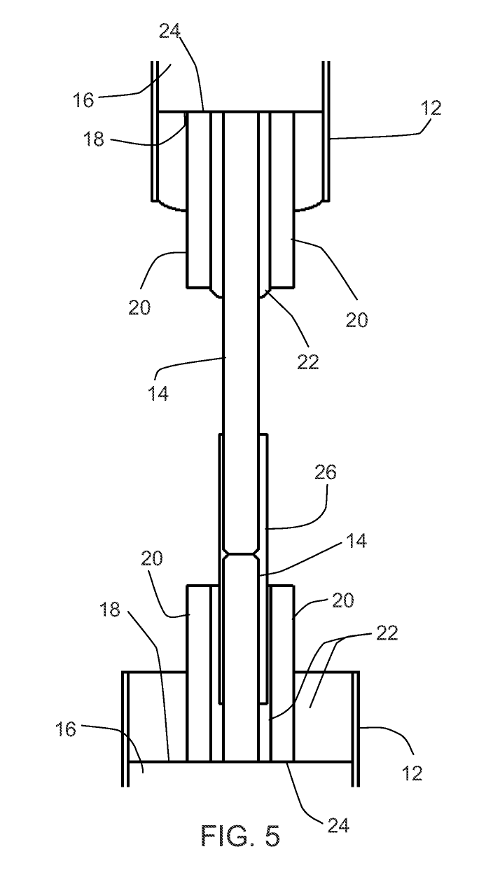

Referring to FIG. 5, once each end of cables 10 are prepared in the manner described above, conductors 14 are electrically connected together. As shown, this is done using a sleeve 26, which may be welded, soldered, brazed and/or crimped in place. It will be understood that sleeve 26 is not necessary, and that other methods of electrically connecting connectors 14 may be used when splicing mineral insulated cables using different approaches, and may be adapted to the present situation as well, such as welding, etc.

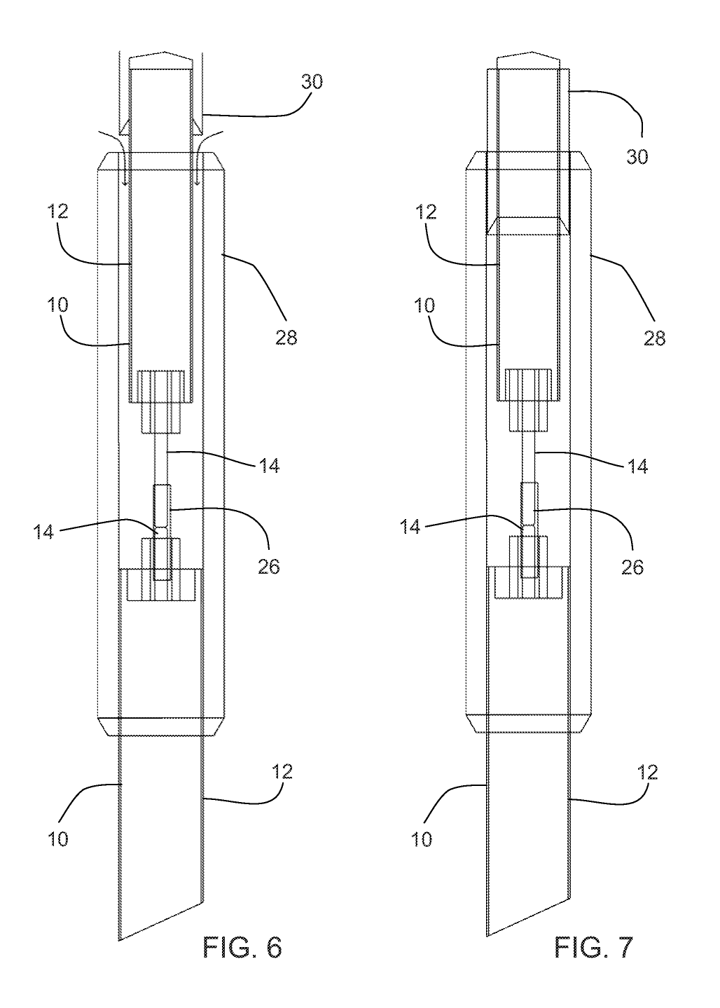

Referring to FIG. 6, once the ends of cables 10 are prepared and conductors 14 are connected, the splice may be completed by placing a cover 28 over the exposed area, such that it connects with cables 10 and covers conductors 14. Preferably, cover 28 overlaps cables 10 such that it can be welded, or otherwise secured, in place. Referring to FIG. 7, cover 28 preferably includes a packing sleeve 30 that is inserted at one end of cover 28 between cable 10 and cover 28. Packing sleeve 30 may be withdrawn, leaving an opening through which mineral insulation may be deposited around conductors 14 and possibly in cavities 18, if necessary. Packing sleeve 30 may then be used to pack the deposited mineral insulation by applying pressure to it. The process is continued until an acceptable level of compaction and fill factor is achieved. Packing sleeve 30 is then attached to both cover 28 and cable 10 to seal the opening, as shown in FIG. 7. It will be understood that other techniques may be used to fill the area between cover 28 and cable 10 with mineral insulation. One method is to fill the area, seal the cover in place, and compress the cover, such as is described in United States Patent Publication No. 2012/0090174. However, the presently described approach to preparing cables 10 to be spliced reduces the need for high compaction by protecting the most sensitive areas with a high dielectric material that is unrelated to the mineral insulation. Accordingly it is not necessary to achieve such a high level of compaction. Furthermore, the process of compressing the cover also induces stresses on various parts of the cable and splice generally, which can increase the likelihood of either mechanical failure or arcing.

As shown in FIGS. 6 and 7, the splice is used to connect cables 12 of different sizes. It will be understood, however, that the splice may also be used to connect cables of the same size. This can be done, for example, by adjusting the dimensions of cover 28, which may not be consistent on either size, to make room for packing sleeve 30, if used.

In addition, while not shown, the splice may be used to connect a mineral insulated cable 12 to a low temperature (e.g. non-mineral insulated) cable. In this situation, the mineral insulated cable 12 will be prepared as described above, and conductor 14 will be connected to a corresponding conductor in the low temperature cable. The non-mineral insulated cable may be stripped as is known in the art to expose the corresponding conductor. Cover 28 will be filled with an electrically insulating material, and may a low temperature material rather than a high temperature material if desired. Cover 28 may be attached to the low temperature cable using known techniques.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples, but should be given the broadest interpretation consistent with the description as a whole.

What is claimed is:

1. A splice for splicing opposed ends of mineral insulated cables, each mineral insulated cable comprising a jacket surrounding a conductor, and mineral insulation insulating the conductor from the jacket, the mineral insulation being recessed from the end of each mineral insulated cable, such that a length of conductor is exposed, the splice comprising:
an insulating sleeve disposed over a portion of the exposed length of each conductor, the insulating sleeve being positioned immediately adjacent to the mineral insulation;
a sealant that seals the insulating sleeve to the mineral insulation;
a connector for electrically connecting the conductors at a point between the respective insulating sleeves; and
a cover for covering the ends of the mineral insulated cables.

2. The splice of claim 1, wherein the sealant comprises a potting compound.

3. The splice of claim 2, wherein the potting compound is aqueous or non-aqueous.

4. The splice of claim 1, wherein the sealant comprises one or more layers.

5. The splice of claim 1, wherein the sealant is injected between the electrically insulating sleeve and the conductor.

6. The splice of claim 1, wherein the sealant fills the recess at the end of each mineral insulated cable.

7. The splice of claim 1, wherein the connector comprises a sleeve of electrically conductive material.

8. The splice of claim 1, wherein the connector comprises a weld.

9. The splice of claim 1, wherein the cover is filled with mineral insulation.

10. The splice of claim 7, wherein the cover further comprises a sliding sleeve positioned between the cover and one of the mineral insulated cable, the sliding sleeve being withdrawn to form an opening through which mineral insulation is inserted.

11. A method of preparing a mineral insulated cable for splicing, the mineral insulated cable comprising a jacket, a conductor positioned within the jacket, and mineral insulation separating the conductor from the jacket, the method comprising the steps of:
forming a cavity at an end of the mineral insulated cable within the jacket by removing a portion of the mineral insulation immediately adjacent to the conductor;
placing a dielectric sleeve over the conductor such that a first end of the sleeve is adjacent to the extends into the cavity; and
sealing the dielectric sleeve in the cavity.

12. The method of claim 11, further comprising the steps of:
electrically connecting the conductors of each mineral insulated cable to each other;
placing a cover that extends between the jackets of each mineral insulated cable and covers the connection of the conductors; and
filling the cover with mineral insulation.
